(19) United States
(12) Patent Application Publication
(10) Pub. No.: US 2025/0189186 A1
(43) Pub. Date: Jun. 12, 2025

(54) DRINKABLE ICE BANK SYSTEMS AND METHODS

(71) Applicant: Hydration Labs, Inc., Charlestown, MA (US)

(72) Inventors: David WATT, Charlestown, MA (US); Andrew John JASKEY, Gloucester, MA (US)

(21) Appl. No.: 18/973,710

(22) Filed: Dec. 9, 2024

Related U.S. Application Data
(60) Provisional application No. 63/607,263, filed on Dec. 7, 2023.

(51) Int. Cl. F25B 39/02; B67D 1/08

(52) U.S. Cl. CPC F25B 39/02; B67D 1/0857; F25B 2339/0242

(57) ABSTRACT

An evaporator can include a pressure vessel and an evaporation device. The evaporation device can be at least partially enclosed within the pressure vessel and configured to direct a refrigerant through the pressure vessel. The evaporator can include at least one fluid direction device at least partially enclosed within the pressure vessel. The at least one fluid direction device is configured to direct a drinking fluid around the evaporation device to facilitate heat exchange. The evaporation device can include an evaporation coil with a first portion, a second portion, and a third portion. The second portion can be located exterior to the first portion and the third portion can be located radially exterior to the second portion. The pressure vessel can include an inlet and outlet in fluid connection with the evaporation coil.

### CROSS-REFERENCE TO RELATED APPLICATIONS

This application claims priority to, and the benefit of, U.S. Provisional Patent Application No. 63/607,263, filed Dec. 7, 2023, entitled “Drinkable Ice Bank Systems and Methods,” the disclosure of which is incorporated by reference in its entirety.

### TECHNICAL FIELD

The present systems and processes relate to refrigeration and chiller systems for beverage dispensers.

### BACKGROUND

Refrigeration and chiller systems are used in beverage dispensers to chill water and syrups for beverage dispensing. Traditional refrigeration and chiller systems can include multiple components and have a relatively large footprint within a beverage dispensing machine. For example, traditional refrigeration and chiller systems may occupy multiple shelves within a beverage dispenser. Additionally, traditional refrigeration and chiller systems may have relatively small capacity for chilled water or syrups (e.g., volume of water or syrup already chilled and available to be dispensed on demand). Traditional refrigeration and chiller systems typically use a two-stage process with a separate beverage coil and evaporator coil. An intermediate working fluid exchanges heat between the beverage coil and evaporator coil to prevent freezing on the beverage coil and damage to the system. The two-stage system is bulky, expensive to produce and maintain, and inefficient.

Therefore, there is a long-felt but unresolved need for compact, high capacity, and efficient refrigeration systems for use in beverage dispensing machines.

### BRIEF SUMMARY OF THE DISCLOSURE

Briefly described, and according to one embodiment, aspects of the present disclosure generally relate to drinkable ice bank systems. The disclosed drinkable ice bank can include an evaporator coil. A refrigerant or working fluid can be pumped through the evaporator coil or other evaporator device (e.g., evaporator plates, evaporator sheets, heat pipes). The refrigerant or working fluid can include any refrigerant capable of a phase change to facilitate heat exchange. As will be understood by those having skill in the art, the refrigerant can be pumped into the evaporator coil at a low temperature and a low pressure. The evaporator coil can be submerged in water in a potable water reservoir (hereinafter “reservoir”). The water in the potable water reservoir tank can be continuously pumped through the reservoir and over and around the evaporator coils. As the water flows over the evaporator coils, heat from the water is transferred to the refrigerant in the evaporator coils, thus cooling the water. The water pumped through the reservoir can be dispensed, pumped into a carbonation device, or mixed for a chilled beverage.

The water can be continuously pumped around the evaporator coil via a recirculation pump. As will be understood by those having skill in the art, ice can form around the evaporator coils. Continuously pumping the water allows for channels to form through the ice, such that water can continue to flow around the evaporator coil without completely freezing. Continuously pumping the water via the recirculation path can enhance heat transfer between the water and the evaporator coils and decrease the recovery time in the event of an interruption. The temperature and pressure of the water can be monitored during recirculation via thermometers and other sensors. In some other embodiments, the water may not be continuously pumped. In these other embodiments, some ice may form on the evaporator coil but may not impede the flow of water through the ice bank. The ice bank can include multiple baffles, fins, or other flow direction devices to direct the flow of water through the reservoir. The baffles can include openings at the bottom or top in an alternating fashion (e.g., the innermost baffle has an opening at the bottom and the adjacent baffle has an opening at the top). The alternating baffle openings can allow for maximum contact between the water and evaporator coils. In some other embodiments, an evaporation device (e.g., evaporator plates, heat pipes) can act as fluid direction devices.

Submerging the evaporator coil in a potable water reservoir can eliminate the two-stage process (e.g., beverage coil and intermediate working fluid) found in evaporators for traditional chiller systems and improve the heat transfer between the refrigerant in the evaporator coil and the drinking water. Eliminating the beverage coil and the intermediate working fluid in the disclosed drinkable ice bank system can allow for a smaller footprint and/or higher capacity of chilled water. For example, the volume of drinkable, chilled water in the drinkable ice bank system can be several times greater than traditional chiller systems. As another example, the volume of refrigerant in the drinkable ice bank system can be less than half the volume of refrigerant found in traditional chiller systems. The elimination of the beverage coil, intermediate working fluid, and other components found in traditional chiller systems can reduce the cost of production and footprint of the drinkable ice bank system. Additionally, the elimination of the beverage coil and intermediate working fluid can increase the flexibility of configuration options within the beverage dispenser. The elimination of the beverage coil and intermediate working fluid increases the turbidity of the water, which improves the heat exchange.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A illustrates a drinkable ice bank evaporator coil according to various embodiments of the present disclosure.

FIG. 1B illustrates a drinkable ice bank according to various embodiments of the present disclosure.

FIG. 1C illustrates a drinkable ice bank according to various embodiments of the present disclosure.

FIG. 1D illustrates a drinkable ice bank according to various embodiments of the present disclosure.

FIG. 1E illustrates a drinkable ice bank according to various embodiments of the present disclosure.

FIG. 1F illustrates a drinkable ice bank according to various embodiments of the present disclosure.

FIG. 1G illustrates a drinkable ice bank according to various embodiments of the present disclosure.

FIG. 2A illustrates a cross-sectional view of a drinkable ice bank according to various embodiments of the present disclosure.

FIG. 2B illustrates a cross-sectional view of a drinkable ice bank according to various embodiments of the present disclosure.

FIG. 2C illustrates fins for the drinkable ice bank according to various embodiments of the present disclosure.

FIG. 3 illustrates a drinkable ice bank system according to various embodiments of the present disclosure.

FIG. 4A illustrates a drinkable ice bank according to various embodiments of the present disclosure.

FIG. 4B illustrates a drinkable ice bank according to various embodiments of the present disclosure.

FIG. 4C illustrates a drinkable ice bank according to various embodiments of the present disclosure.

FIG. 5A illustrates a drinkable ice bank according to various embodiments of the present disclosure.

FIG. 5B illustrates a drinkable ice bank according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

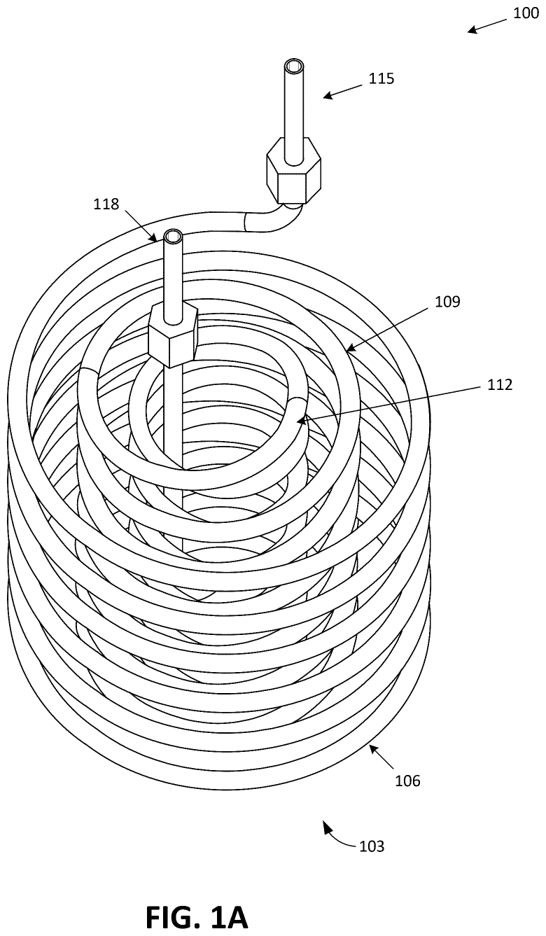

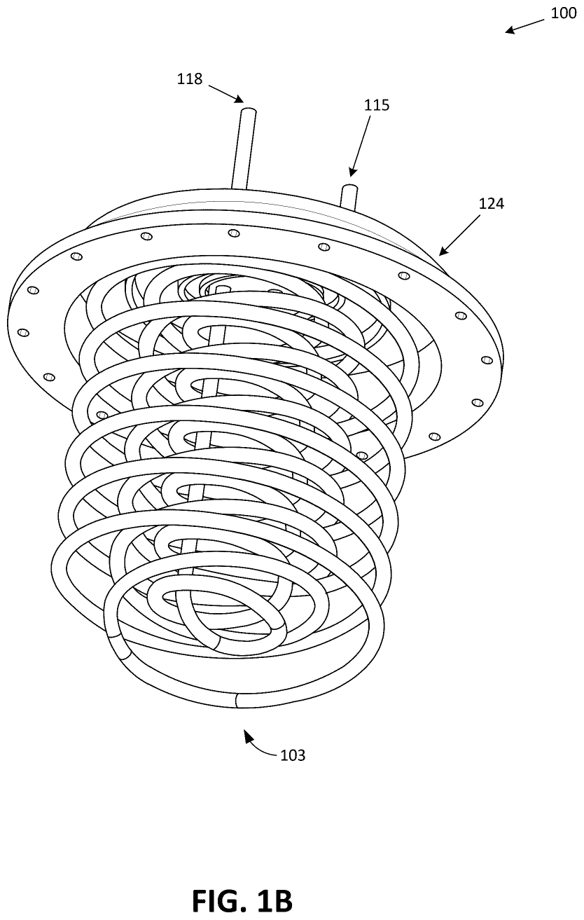

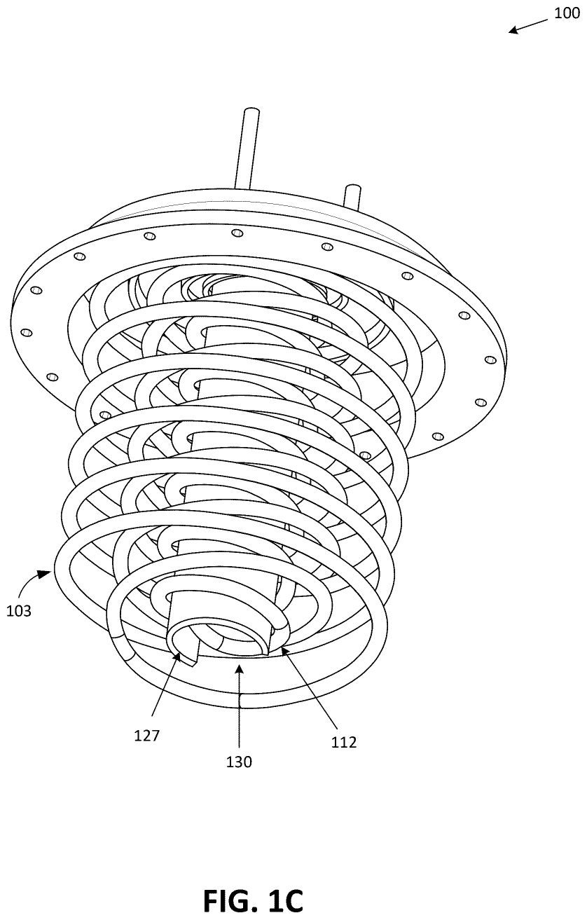

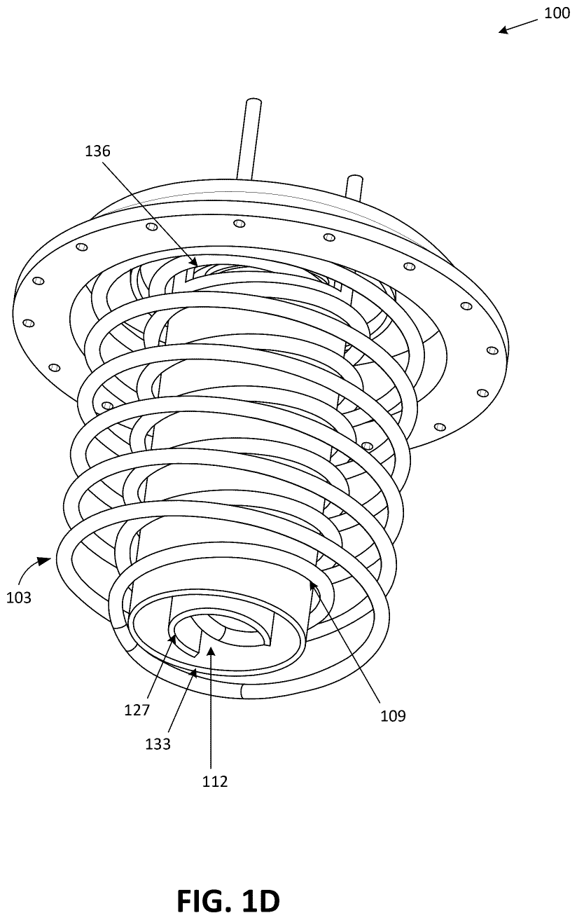

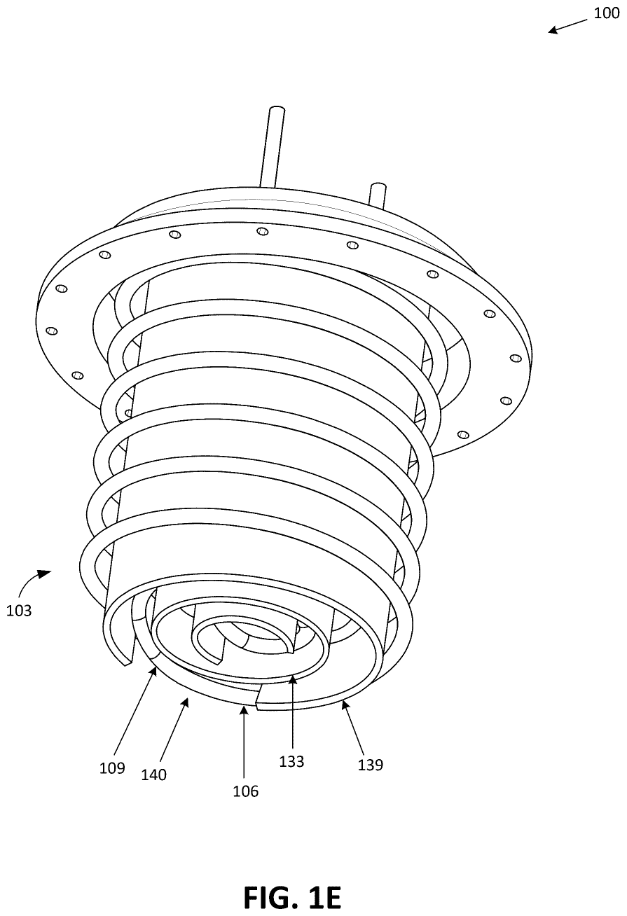

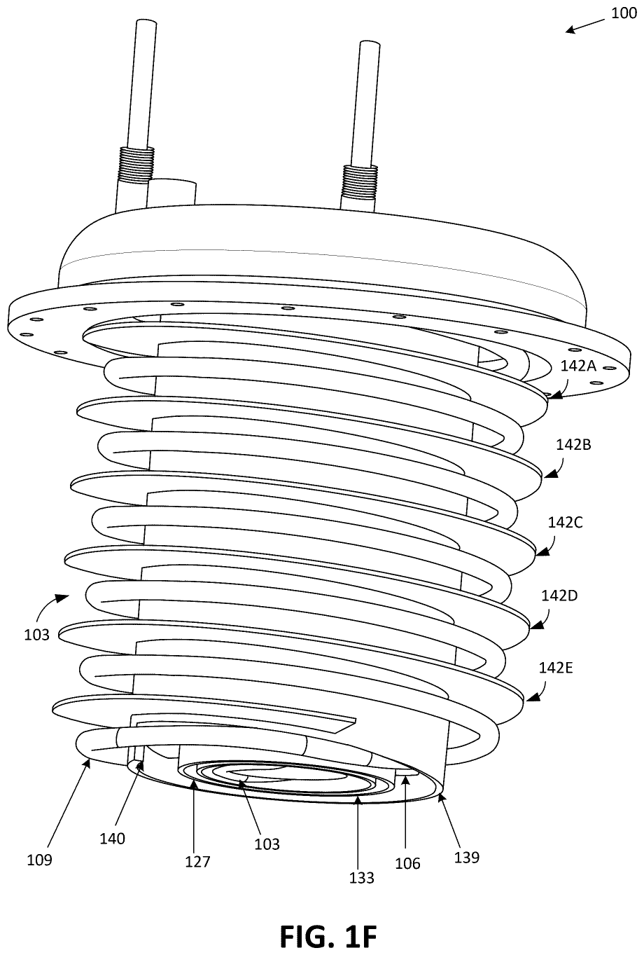

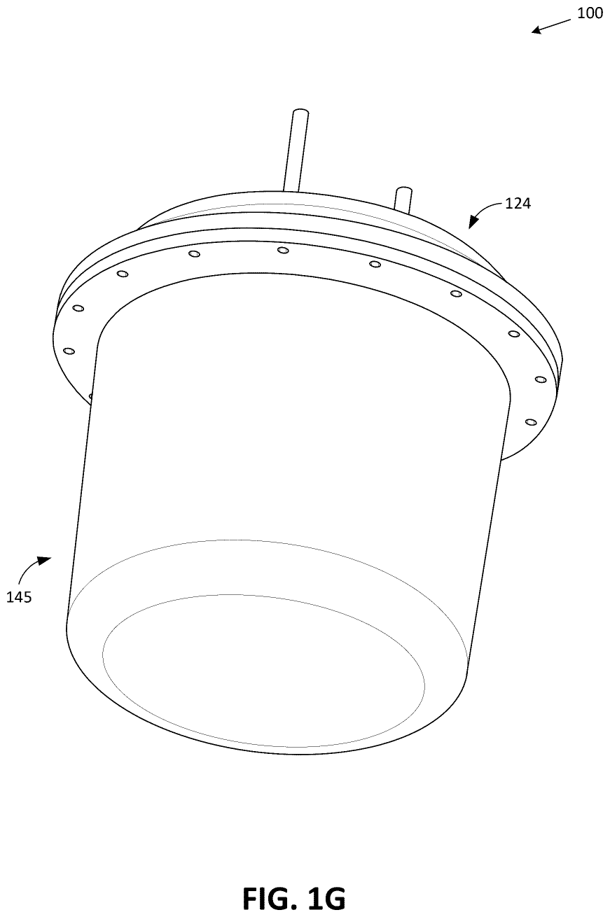

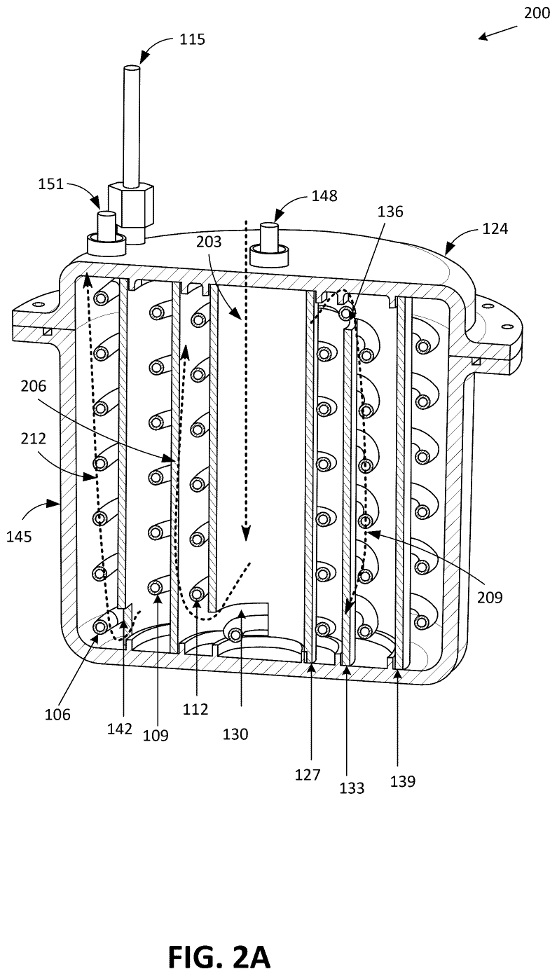

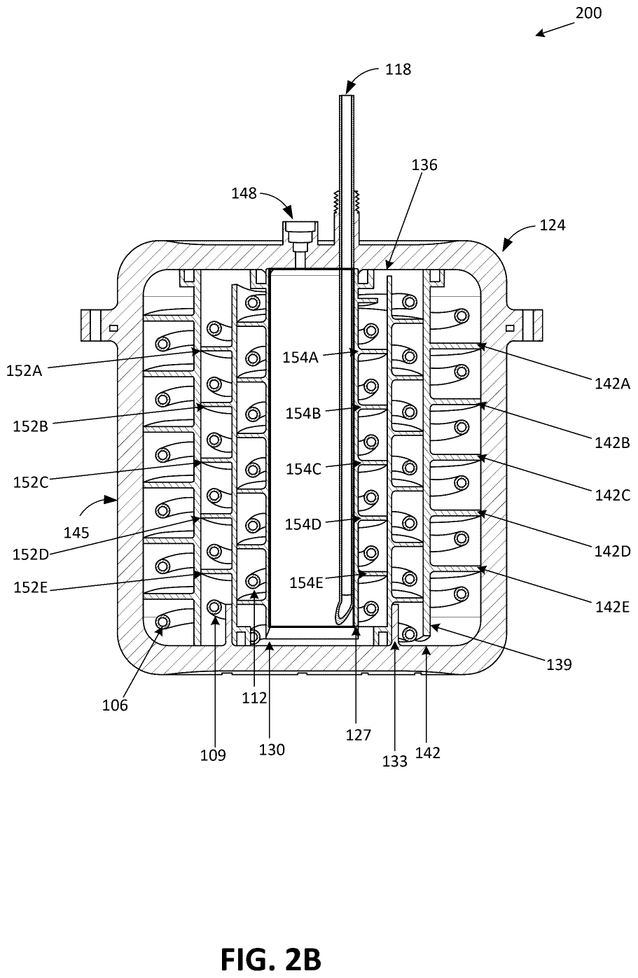

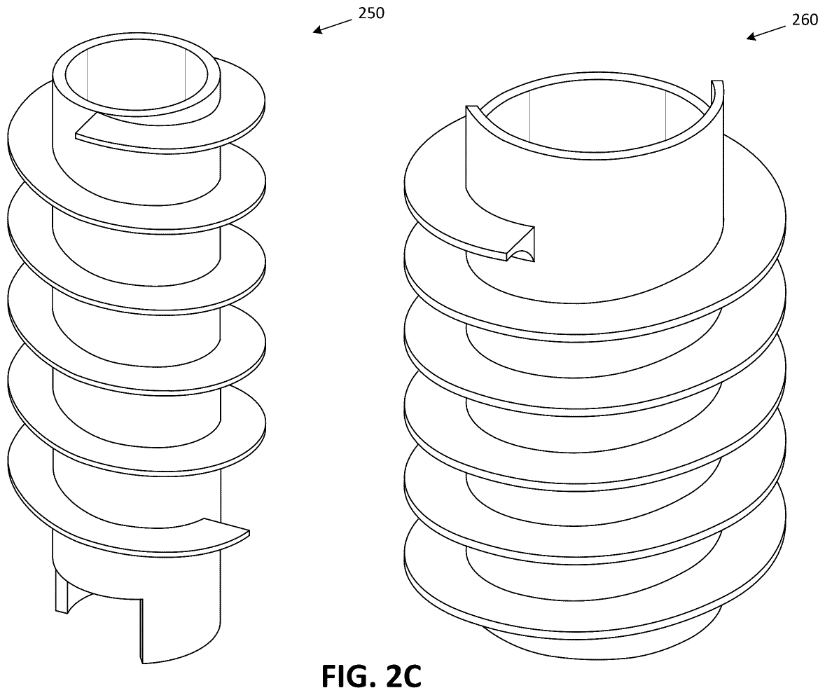

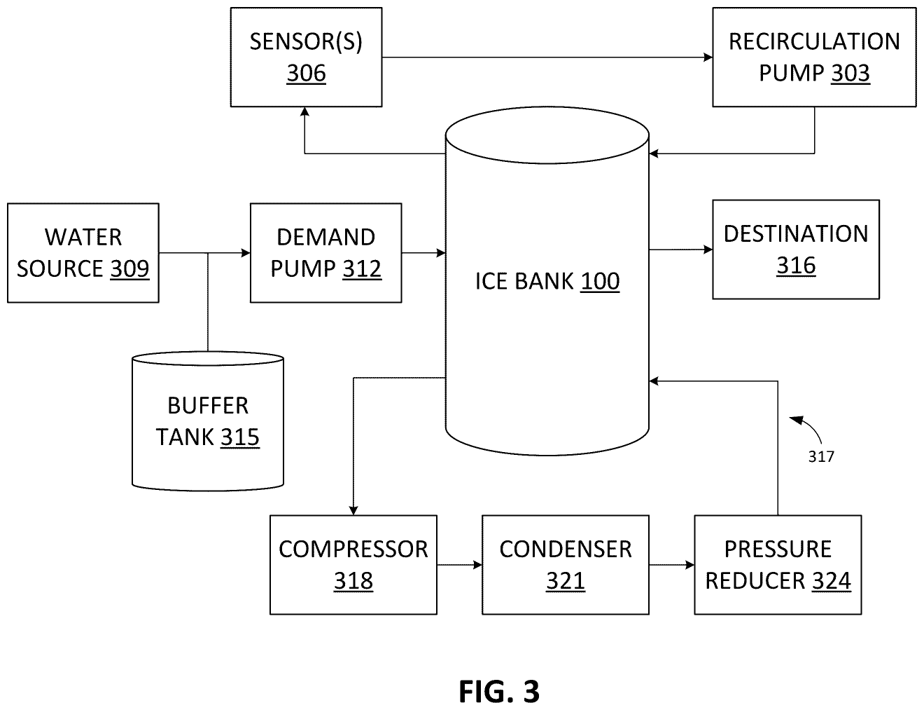

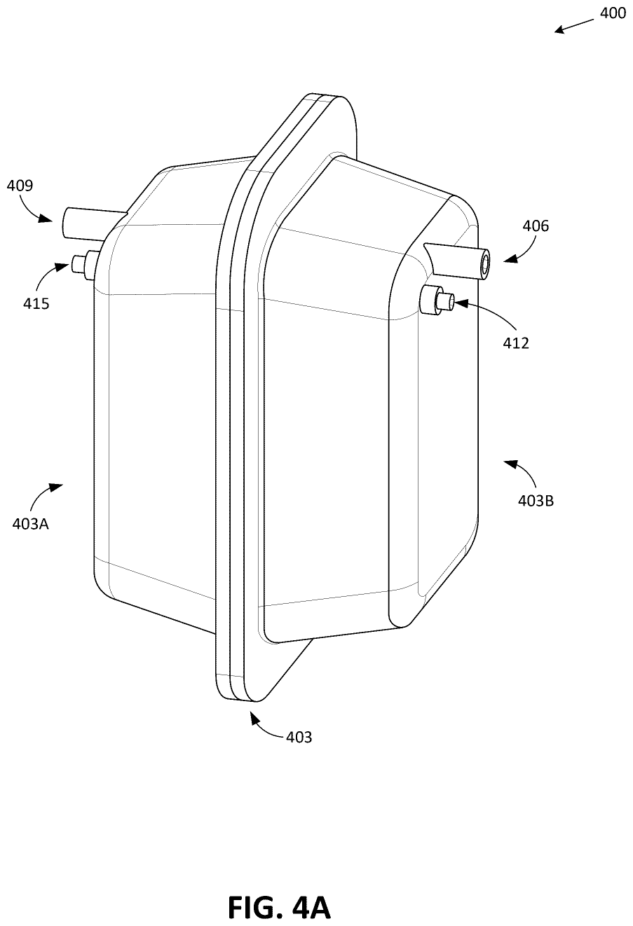

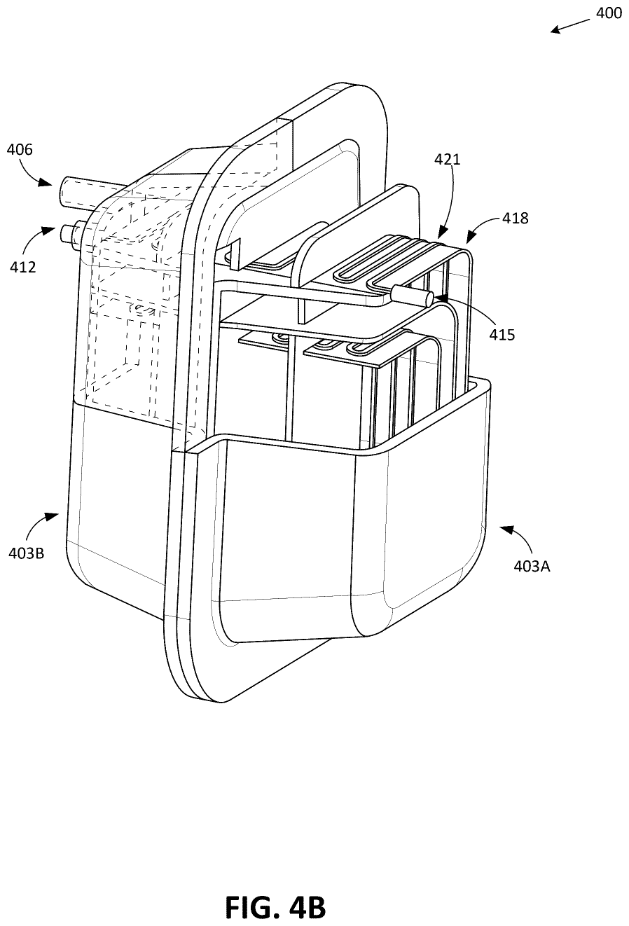

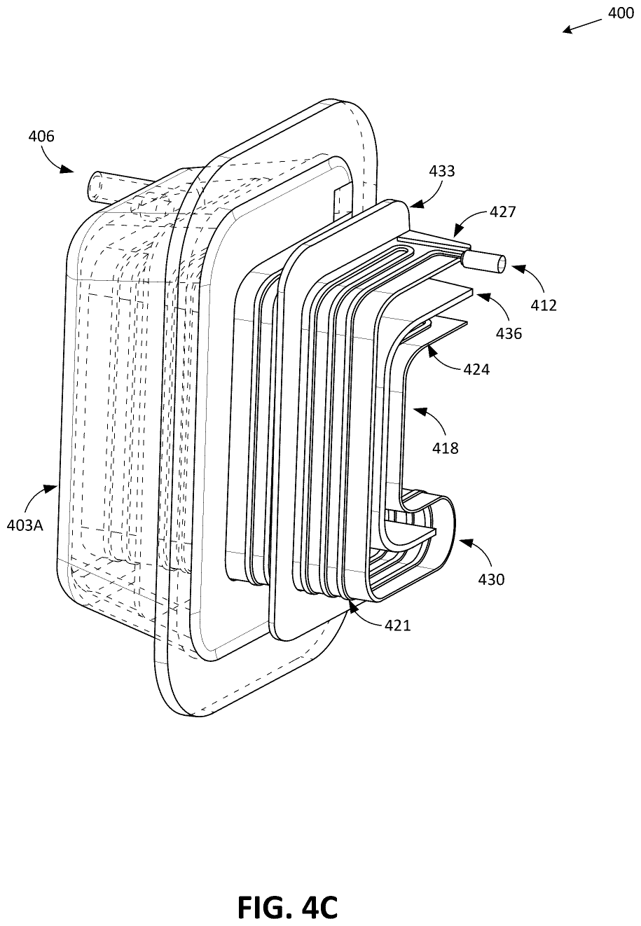

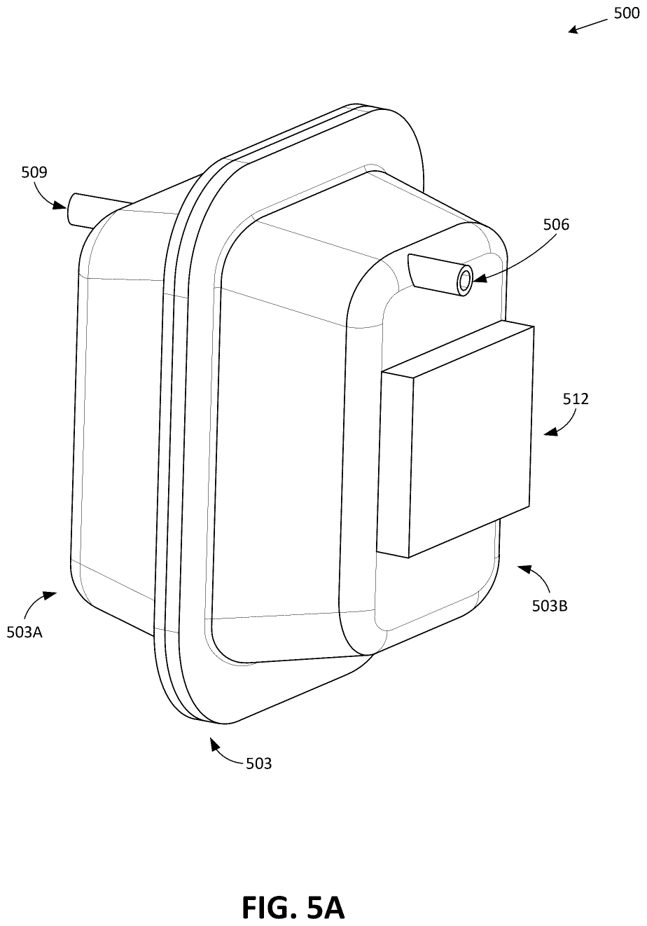

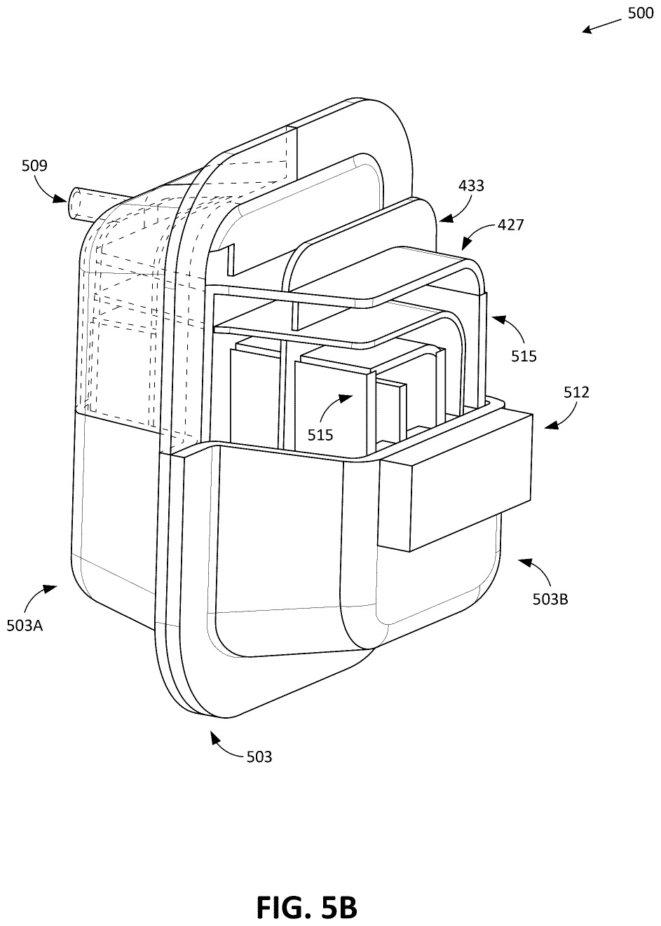

Referring now to the figures, for the purposes of example and explanation of the fundamental processes and components of the disclosed systems and processes, reference is made to FIG. 1A, which illustrates an exemplary drinkable ice bank 100 (hereinafter “ice bank 100”). As will be understood and appreciated, the ice bank 100 shown in FIGS. 1A-1G and FIGS. 2A-2C, the ice bank 500 shown in FIGS. 4A-4C, the ice bank 500 shown in FIGS. 5A and 5B, and the drinkable ice bank system 300 shown in FIG. 3 represent merely one approach or embodiment of the present system, and other aspects are used according to various embodiments of the present system.

The ice bank 100 can include an evaporator coil 103. The evaporator coil 103 can be a helical coil. The evaporator coil 103 can include a triple helix with three concentric helixes: an outer helix 106, a middle helix 109, and an inner helix 112. The outer helix 106 can be located on the outermost portion of the evaporator coil 103 with the inner helix 112 located in the innermost portion of the evaporator coil 103 (e.g., located closest to the center of the evaporator coil 103). The middle helix 109 can be located between the outer helix 106 and the inner helix 112. In some embodiments, the evaporator coil 103 can include any number of concentric helixes. As will be understood, each of the helixes (e.g., the outer helix 106, the middle helix 109, the inner helix 112) can include any number of twists (e.g., any number more than 1 capable of fitting in the ice bank 100).

The evaporator coil 103 can be a hollow tubing or conduit. The evaporator coil 103 can be hollow so that refrigerant (e.g., liquid, vapor, liquid-vapor mixture) can flow continuously through the outer helix 106, the middle helix 109, and the inner helix 112. The evaporator coil 103 can be manufactured out of any conductive metals, including but not limited to stainless steel, carbon steel, copper, aluminum, and nickel coated copper.

A refrigerant can be pumped through the evaporator coil 103. The refrigerant can include any refrigerant or a working fluid capable of a phase change including but not limited to hydrofluorocarbons, hydrocarbons, carbon dioxide, and hydrofluoroolefins. The refrigerant can enter or exit the evaporator coil 103 via the coil ports 115 and 118. The coil ports 115 and 118 can be located at opposite ends of the evaporator coil 103. For example, the coil port 115 can be located at the end of the outer helix 106 and the coil port 118 can be located at the end of the inner helix 112. The refrigerant can be pumped through the evaporator coil 103 in either direction. For example, the refrigerant can be pumped into the evaporator coil 103 via the coil port 115, through the outer helix 106, followed by the middle helix 109 and the inner helix 112, and then exit the evaporator coil 103 via the coil port 118. As another example, the refrigerant can be pumped into the evaporator coil 103 via the coil port 118, through the inner helix 112, followed by the middle helix 109 and the outer helix 106, and then exit the evaporator coil 103 via the coil port 115. As will be understood by one having skill in the art, the refrigerant can enter the evaporator coil 103 at a low temperature.

Referring now to FIG. 1B, shown is an exemplary view of the ice bank 100 according to various embodiments of the present disclosure. The evaporator coil 103 can be mounted to a pressure vessel cap 124. The pressure vessel cap 124 can maintain pressure in a reservoir or pressure vessel containing the evaporator coil 103. The pressure vessel cap 124 can seal a reservoir containing the evaporator coil 103 to prevent contamination. The pressure vessel cap 124 can be compatible with a potable water reservoir. The pressure vessel cap 124 can include multiple holes, including holes for the coil ports 115 and 118 to protrude through the top of the pressure vessel cap 124. The pressure vessel cap 124 can be manufactured out of a strong, durable metal, including but not limited to stainless steel, carbon steel, copper, aluminum, and nickel. The pressure vessel cap 124 can include a gasket or seal ring for sealing to a reservoir containing the evaporator coil 103.

Referring now to FIG. IC, shown is an exemplary view of the ice bank 100 according to various embodiments of the present disclosure. Baffles can be mounted to the interior of the pressure vessel cap 124. As will be understood, the baffles can include fluid direction devices to direct the flow of water through the reservoir. The baffles can be cylindrical partitions mounted in between the portions of the evaporator coil 103. The baffles can extend from the top to the bottom of the ice bank 100. For example, baffles can be located in the center of the evaporator coil 103 (e.g., in the center of the inner helix 112), in between the inner helix 112 and the middle helix 109, in between the middle helix 109 and the outer helix 106, and outside of the evaporator coil 103 (e.g., outside of the edge of the outer helix 106). Multiple baffles can be mounted in between the portions of the evaporator coil 103 to direct a flow of water around and over the outside of the evaporator coil 103. The ice bank 100 can include any number of baffles to conduct the flow of water around the evaporator coil 103. For example, the ice bank 100 can include 3 baffles. The baffles can be manufactured out of a strong, durable metal, including but not limited to stainless steel, carbon steel, copper, aluminum, plastic (e.g., HDPE, LDPE, PC, PET, PP), and nickel.

A first baffle, the inner baffle 127, can be located in the center of the evaporator coil 103 (e.g., the center of the inner helix 112). The inner baffle 127 can include an opening 130 at the bottom. The opening 130 can be an aperture or cutout at the bottom of the inner baffle 127. The opening 130 can span up to half of the diameter of the inner baffle 127 and be up to 1 inch high. The inner helix 112 can pass through the opening 130 to connect with the coil port 118 at the pressure vessel cap 124.

Referring now to FIG. 1D, shown is an exemplary view of the ice bank 100 according to various embodiments of the present disclosure. The second baffle, the middle baffle 133, can be located in between the inner helix 112 and the middle helix 109. The middle baffle 133 can include an opening 136 at the top. The opening 136 can be an aperture or cutout at the top of the middle baffle 133. The opening 136 can span up to half of the diameter of the middle baffle 133. The inner helix 112 can pass through the opening 136 to connect with the middle helix 109.

Referring now to FIG. 1E, shown is an exemplary view of the ice bank 100 according to various embodiments of the present disclosure. The third baffle, the outer baffle 139, can be located in between the middle helix 109 and the outer helix 106. The outer baffle 139 can include an opening 142 at the top. The opening 142 can be an aperture or cutout at the top of the outer baffle 139. The opening 142 can span up to half of the diameter of the outer baffle 139. The middle helix 109 can pass through the opening 142 to connect with the outer helix 106.

Referring now to FIG. IF, shown is an exemplary view of the ice bank 100 according to various embodiments of the present disclosure. In some embodiments, one or more of the baffles (e.g., the inner baffle 127, the middle baffle 133, the outer baffle 139) can include fins. For example, the outer baffle 139 can include the fins 142A-E. The baffles can include any number of fins. For example, the baffles can include a fin between each twist in each helix (e.g., the outer helix 106, the middle helix 109, the inner helix 112). The fins can include partitions that extend perpendicularly from the surface of the baffle.

Referring now to FIG. 1G, shown is an exemplary view of the ice bank 100 according to various embodiments of the present disclosure. The evaporator coil 103 and the baffles, including the inner baffle 127, the middle baffle 133, and the outer baffle 139 can be contained inside the potable water reservoir or pressure vessel 145 (hereinafter “reservoir 145”). The reservoir 145 can include a cylindrical reservoir with a diameter of approximately 6.5 inches and a height of approximately 7 inches. In some other embodiments, the reservoir 145 can include a rectangular shape reservoir. In some other embodiments, the reservoir 145 can include any width, height, and/or diameter dimensions to provide a sufficient volume of chilled drinking water. The pressure vessel cap 124 can be secured to the top of the reservoir 145 such that the pressure vessel cap 124 maintains an appropriate pressure inside the reservoir 145. The pressure vessel cap 124 can be secured or sealed to the reservoir 145 to prevent contamination inside of the reservoir. For example, the pressure vessel cap 124 can be sealed to the reservoir 145 with a gasket or seal ring and secured to the reservoir 145 with multiple bolts or screws. As another example, the pressure vessel cap 124 can be sealed to the reservoir 145 by ultrasonic welding or other joining process. The reservoir 145 can be manufactured out of any appropriate for potable water, including but not limited to stainless steel or acrylic.

Referring now to FIG. 2A, shown is an exemplary a cross-sectional view 200 of the ice bank 100 according to various embodiments of the present disclosure. The reservoir 145 can be filled with water. The evaporator coil 103 and the baffles can submerged in the water inside of the reservoir 145. Water can enter and exit the reservoir 145 via the water ports 148 and 151. The water ports 148 and 151 can be located on the pressure vessel cap 124. The water port 148 can be located at the center of the pressure vessel cap 124 such that water can enter and exit the reservoir through the inner baffle 127. The water port 151 can be located at the edge of the pressure vessel cap 124 such that water can enter and exit the reservoir from the outside of the outer baffle 139. As will be understood by one having ordinary skill in the art, the water can enter the reservoir 145 at room temperature or a high temperature. For example, the water can enter the reservoir 145 at a higher temperature than the temperature of the refrigerant entering the evaporator coil 103.

As illustrated by flow lines 203, 206, 209, and 212, water can enter the reservoir 145, flow over and around the evaporator coil 103 and the baffles, and exit the reservoir 145. As will be understood by those having ordinary skill in the art, the flow lines 203, 206, 209, and 212 are included for illustrative purposes. For example, as illustrated by the flow line 203, water can enter into the reservoir 145 via the water port 148 in the center of the pressure vessel cap 124. The water can flow down through the center of the inner baffle 127 and through the opening 130. After flowing through the opening 130, the water can flow up between the inner baffle 127 and the middle baffle 133 as illustrated by the flow line 206. As water flows up between the inner baffle 127 and the middle baffle 133, the water can pass over the inner helix 112. As the water flows over and around the evaporator coil 103, the heat from the water can be transferred to the evaporator coil 103 due to the low temperature of the refrigerant in the evaporator coil 103 compared to the temperature of the water. After flowing between the inner baffle 127 and the middle baffle 133, the water can flow through the opening 136 and down between the middle baffle 133 and the outer baffle 139 as illustrated by the flow line 209. As water flows down between the middle baffle 133 and the outer baffle 139, the water can pass over the middle helix 109. As the water flows over the middle helix 109, heat can continue to be transferred from the water to the evaporator coil 103. After flowing between the middle baffle 133 and the outer baffle 139, the water can flow through the opening 142 and down between the outer baffle 139 and the side of the reservoir 145 as illustrated by the flow line 212. As water flows down between the outer baffle 139 and the side of the reservoir 145, the water can pass over the outer helix 106. As the water flows over the outer helix 106, heat can continue to be transferred from the water to the evaporator coil 103. Water can exit the reservoir 145 via the water port 151 at the edge of the pressure vessel cap 124.

As will be understood by one having skill in the art, the direction of the flow of water can be reversed. For example, water can enter the reservoir 145 via the water port 151, flow down between the side of the reservoir 145 and the outer baffle 139, through the opening 142, down between the outer baffle 139 and the middle baffle 133, through the opening 136, up between the middle baffle 133 and the inner baffle 127, through the opening 130, up through the center of the inner baffle 127, and exit the reservoir 145 via the water port 148

The alternating location of the openings 130, 136, and 142 can maximize the contact between the water and the evaporator coil 103 and thus maximize the heat transfer between the water and the evaporator coil 103. The opening 130 can be located at the bottom of the inner baffle 127, the opening 136 can be located at the top of the middle baffle 133, and the opening 142 can be located at the bottom of the outer baffle 139. The alternating locations of the openings 130, 136, and 142 can direct the flow of water over the evaporator coil 103 in alternating directions (e.g., up or down), which can maximize the contact between the water and the evaporator coil 103.

Referring now to FIG. 2B, shown is an exemplary a cross-sectional view 200 of the ice bank 100 according to various embodiments of the present disclosure. In some embodiments, the baffles (e.g., the inner baffle 127, the middle baffle 133, the outer baffle 139) can include fins. For example, the outer baffle 139 can include the fins 142A-E located between each twist of the outer helix 106. As another example, the middle baffle 133 can include the fins 152A-E located between each twist of the middle helix 109. As another example, the outer baffle 139 can include the fins 154A-E located between each twist of the inner helix 112. While in this exemplary view 200, each baffle includes 5 fins, each baffle can include any number of fins. For example, each baffle can include a fin between each twist. The fins can direct the flow of the water around and over the evaporator coil 103.

Referring now to FIG. 2C, shown are exemplary fins 250 and 260 of the ice bank 100 according to various embodiments of the present disclosure. The fins 250 and 260 can be helical partitions mounted to the baffles 127, 133, and 139. The fins 250 and 260 can be any flow direction device capable of directing the flow of water over and around the evaporator coil 103. The fins 250 and 260 can enhance the heat exchange between the water and the refrigerant in the evaporator coil 103.

Referring now to FIG. 3, shown is an exemplary view of the drinkable ice bank evaporator system 300 (hereinafter “system 300”) according to various embodiments of the present disclosure. As will be understood, the ice bank 100 can include the evaporator coil 103, the pressure vessel cap 124, the baffles 127, 133, and 139, and the reservoir 145. In some embodiments, the ice bank 100 can include an evaporator. The system 300 can include a recirculation pump 303. The recirculation pump 303 can be any pump capable of pumping water at near freezing temperatures. The recirculation pump 303 can continuously pump the water through the ice bank 100. As water flows over the evaporator coil 103, ice can form around the outside of the evaporator coil 103. Heat energy from the water can flow into the evaporator coil 103 to cool down the water. Since the recirculation pump 303 can continuously pump the water through the ice bank 100, water channels can form around the ice, which can allow water to continue to flow through the ice bank 100. The continuous pumping by the recirculation pump 303 can increase or maximize the heat transfer between the water and the evaporator coils 103. The continuous pumping by the recirculation pump 303 can minimize the amount of time necessary for the system 300 to recover in the event of an interruption or temperature increase.

The recirculation line (e.g., the tubes or conduit supplying the recirculation pump 303 from the ice bank 100) can include sensors 306. The sensors 306 can include any sensor for measuring a characteristic of the water, including but not limited to thermometers, pressure sensors, level sensors, and ice sensors. The sensors 306 can monitor the water to ensure that the water does not completely freeze around the evaporation coils 103. The sensors 306 can determine if the temperature of the water is appropriate for dispensing into a beverage. The sensors 306 can determine the amount, volume, or level of water in the reservoir 145.

The system 300 can include a water source 309. The water source 309 can be a water line in a residential or commercial building. The water source 309 can supply cold or hot water. For example, the water source 309 can supply water at a temperature higher than the temperature of the refrigerant in the ice bank 100. The water source 309 can be connected to the system 300 via a conduit, tube, or hose.

The system 300 can include a demand pump 312. The demand pump 312 can either pump water out of the ice bank 100 when needed to dispense a beverage or pump water into the ice bank 100 to maintain the appropriate pressure in the reservoir 145. The reservoir 145 can hold several liters of chilled water, so the demand pump 312 can pump the water out of the reservoir 145 to make a beverage or pump water into the reservoir 145 to maintain the appropriate pressure (e.g., a threshold pressure). The demand pump 312 can be any pump capable of pumping water at near freezing temperatures. A buffer tank 315 can be located before or after the demand pump 312 to help maintain the appropriate pressure in the reservoir 145. When water is pumped out of the ice bank 100, water can be pumped to a destination 316, which can include a carbonation device, a dispensing device, or a mixing device (e.g., a device for mixing the chilled water with a syrup or flavor additive).

The system 300 can include a closed loop 317, including the ice bank 100, a compressor 318, a condenser 321, and a pressure reducer 324. The refrigerant can be enclosed within the closed loop 317, such that the refrigerant does not come in direct contact with the water in the system 300. As will be understood, the components in the closed loop 317 (e.g., the compressor 318, the condenser 321, pressure reducer 324) can facilitate and/or cause decreasing the temperature of the refrigerant such that when the refrigerant enters the ice bank 100, the refrigerant is an appropriate temperature for heat exchange with the water. In some other embodiments, alternate cooling systems, such as thermoelectric coolers and heat plates can be used in place of or in addition to the closed loop 317 and its components (e.g., the compressor 318, the condenser 321, pressure reducer 324).

The refrigerant can enter the ice bank 100 (e.g., the evaporator coil 103) as a mixture of gas and liquid. The refrigerant can leave the ice bank 100 (e.g., the evaporator coil 103) as a gas due to the heat exchange with the water in the reservoir 145. The compressor 318 increases the pressure and temperature of the refrigerant by compressing the refrigerant. The refrigerant enters the compressor 318 in a low temperature and low pressure state in the gas phase. The compressor 318 can compress the gaseous refrigerant to increase the temperature and the pressure of the refrigerant. The condenser 321 can transform the refrigerant from a gas or vapor back into a liquid, vapor, or liquid-vapor mixture. By converting the refrigerant from a gas into a liquid, the condenser 321 can allow the refrigerant to release the heat that was absorbs from the water in the ice bank 100. The pressure reducer 324 can reduce the pressure of the refrigerant before enter the ice bank 100. By reducing the pressure of the refrigerant, the pressure reducer 324 can reduce the temperature of the refrigerant so that the refrigerant can enter the ice bank 100 as a mixture of gas and liquid.

Referring now to FIG. 4A, shown is an exemplary view of the ice bank 400 according to various embodiments of the present disclosure. The ice bank 400 can include any of the parts or aspects discussed with reference to FIGS. 1A-1G, FIGS. 2A-2C, and FIG. 3. As will be understood, FIGS. 1A-1G, FIGS. 2A-2C, and FIG. 3 can illustrate example configurations of the ice bank 100. The disclosed technology includes various combination of the various aspects and/or configurations disclosed herein, even if a given combination is not explicitly illustrated or described herein. For example, one or more of the example configurations shown and described below with respect to FIGS. 4A-4C and FIGS. 5A and 5B include some or all of the elements shown and described with respect to FIGS. 1A-1G, FIGS. 2A-2C, and FIG. 3. As another example, one or more of the example configurations show and described above with respect to FIGS. 1A-1G, FIGS. 2A-2C, and FIG. 3 include some or all of the elements shown and described with respect to FIGS. 4A-4C and FIGS. 5A and 5B.

The ice bank 400 can include a reservoir or pressure vessel 403 (“reservoir 403”). For example, the reservoir 403 can include a rectangular or polygonal shaped reservoir. The reservoir 403 can include two half reservoirs 403A and 403B. Each half reservoir (e.g., half reservoir 403A or 403B) can form half of the reservoir. The half reservoirs 403A and 403B can be joined by any suitable method (e.g., screws, bolts, fasteners) in a clamshell configuration. The reservoir 403 can include a water inlet 406 and a water outlet 409. Water can enter the reservoir 403 for chilling via the water inlet 406 and can exit the reservoir 403 chilled via the water outlet 409. The reservoir 403 can include a refrigerant inlet 412 and a refrigerant outlet 415. Refrigerant can enter the reservoir 403 via the refrigerant inlet 412 and can exit the reservoir 403 via the refrigerant outlet 415. In some embodiments, the refrigerant inlet 412 and the refrigerant outlet 415 can reverse (e.g., refrigerant can enter the reservoir 403 via the refrigerant outlet 415 and can exit the reservoir 403 via the refrigerant inlet 412) to maximize heat exchange with the water. The refrigerant inlet 412 and refrigerant outlet 415 can be in fluid connection with the closed loop described in FIG. 3 (e.g., compressor, condenser, pressure reducer) or some other cooling system (e.g., thermoelectric chiller and/or heat plates).

Referring now to FIG. 4B, shown is an exemplary view of the ice bank 400 according to various embodiments of the present disclosure. The ice bank 400 can include one or more plate or sheet evaporators 418 (plate evaporators 418). The plate evaporators 418 can include flat and curved partitions located on the interior of the reservoir 403. The plate evaporators 418 can include an embedded evaporator conduit 421 along the surface of the plate evaporators 418. For example, the evaporator conduit 421 can extend the length of the plate evaporators 418, then turn 180 degrees, and extend the length of the plate evaporators 418 in a loop or zig zag pattern (e.g., boustrophedonic) down the width of the plate evaporators 418. In some embodiments, the plate evaporator 418 can include evaporator conduit 421 on both sides of each plate evaporator 418. The refrigerant can be pumped through the evaporator conduit 421 and exchange heat with the water the passes over and around the surface of the plate evaporators 418.

Referring now to FIG. 4C, shown is an exemplary view of the ice bank 400 according to various embodiments of the present disclosure. Each half reservoir (e.g., half reservoir 403A or 403B) can include a plate evaporator 418 in an arched-shaped or penannular configuration. For example, the plate evaporator 418 can include two parallel plates 424 and 427 in an arched-shaped or penannular configuration connected by a 180 degree bend 430. The plate evaporators 418 can include one or more baffles 433 and 436. The baffles can include flat and/or curved partitions that extend perpendicularly from the surface of the plate evaporators 418 or extend parallel to the surface of the plate evaporators 418. For example, baffle 433 can extend perpendicular from the surface of the plate evaporator 418 and baffle 436 can be positioned between the parallel plates 424 and 427.

Referring now to FIG. 5A, shown is an exemplary view of the ice bank 500 according to various embodiments of the present disclosure. The ice bank 500 can include any of the parts or aspects discussed with reference to FIGS. 1A-IG, FIGS. 2A-2C, FIG. 3, and FIGS. 4A-4C. The ice bank 500 can include a reservoir or pressure vessel 503 (“reservoir 503”). For example, the reservoir 503 can include a rectangular or polygonal shaped reservoir. The reservoir 503 can include two half reservoirs 503A and 503B. Each half reservoir (e.g., half reservoir 503A or 503B) can form half of the reservoir. The half reservoirs 503A and 503B can be joined by any suitable method (e.g., screws, bolts, fasteners) in a clamshell configuration. The reservoir 503 can include a water inlet 506 and a water outlet 509. Water can enter the reservoir 503 for chilling via the water inlet 506 and can exit the reservoir 503 chilled via the water outlet 509.

The ice bank 500 can include a thermoelectric cooler 512. The thermoelectric cooler 512 can lower the temperature of the refrigerant such that the refrigerant can exchange heat with the water in the reservoir 503. As will be understood, the thermoelectric cooler can be used in place of or in addition to the closed loop described in FIG. 3 (e.g., compressor, condenser, pressure reducer).

Referring now to FIG. 5B, shown is an exemplary view of the ice bank 500 according to various embodiments of the present disclosure. The ice bank 500 can include one or more heat pipes 515 in a plate configuration. The heat pipes 515 can facilitate heat exchange between the water and the refrigerant by causing the refrigerant to undergo a phase change at the surface of the heat pipe 515. The heat pipe 512 can be in fluid connection with a thermoelectric cooler 512. The ice bank 500 can include one or more baffles 427 and 433. For example, the baffles 427 can include flat and/or curved partitions that form concentric rectangles in the half reservoirs 503A and 503 B. As another example, the baffles 433 can extend perpendicular from the baffles 427 and heat pipes 515.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be affected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Clause 1. An evaporator, comprising: a pressure vessel; an evaporation device at least partially enclosed within the pressure vessel, the evaporation device being configured to direct a refrigerant through the pressure vessel; and at least one fluid direction device at least partially enclosed within the pressure vessel, the at least one fluid direction device being configured to direct a drinking fluid around the evaporation device to facilitate heat exchange.

Clause 2. The evaporator of clause 1, wherein the evaporation device comprises an evaporation coil.

Clause 3. The evaporator of clause 2, wherein the evaporation coil comprises a first portion, a second portion, and a third portion, wherein the second portion is located radially exterior to the first portion and the third portion is located radially exterior to the second portion.

Clause 4. The evaporator of clause 2, wherein the evaporation coil is in fluid connection with an inlet and outlet of the pressure vessel.

Clause 5. The evaporator of clause 1, wherein the evaporation device comprises at least one evaporator fin.

Clause 6. The evaporator of clause 1, wherein the at least one fluid direction device comprises at least one baffle.

Clause 7. The evaporator of clause 6, wherein the at least one baffle comprises a first baffle, a second baffle, and a third baffle, wherein the second baffle is located radially exterior to the first baffle, and the third baffle is located radially exterior to the second baffle.

Clause 8. The evaporator of clause 6, wherein the at least one baffle comprises at least one opening configured to direct the drinking fluid.

Clause 9. The evaporator of clause 6, wherein the at least one baffle comprises at least one fin.

Clause 10. The evaporator of clause 1, wherein the at least one fluid direction device comprises at least one fin.

Clause 11. The evaporator of clause 1, wherein the evaporator excludes an intermediate working fluid between the refrigerant and the drinking fluid.

Clause 12. The evaporator of clause 1, further comprising a pump configured to pump the drinking fluid through the pressure vessel and over the evaporation device to exchange thermal energy with the refrigerant.

Clause 13. The evaporator of clause 1, further comprising at least one temperature sensor configured to measure a temperature of the drinking fluid.

Clause 14. The evaporator of clause 1, further comprising a pressure vessel cap configured to pressurize the pressure vessel.

Clause 15. The evaporator of clause 1, wherein the evaporator is configured to chill the drinking fluid for dispensing.

Clause 16. The evaporator of clause 1, wherein the drinking fluid is supplied to the evaporator via a demand pump.

Clause 17. An evaporator comprising: a pressure vessel; a helical coil positioned within the pressure vessel and comprising an inner portion, a middle portion, and an outer portion, wherein the middle portion is located radially exterior to the inner portion and the outer portion is located radially exterior to the middle portion; a first baffle located radially interior to the inner portion and comprising a first opening at a first lower end of the first baffle; a second baffle positioned between the inner portion and the middle portion and comprising a second opening at a second upper end of the second baffle; and a third baffle positioned between the middle portion and the outer portion and comprising a third opening at a third lower end of the third baffle.

Clause 18. An evaporator system comprising: an evaporator comprising: a pressure vessel comprising an inlet and an outlet; a helical coil enclosed inside the pressure vessel, the helical coil comprising an inner portion, a middle portion, and an outer portion, wherein the middle portion is located radially exterior to the inner portion and the outer portion is located radially exterior to the middle portion, and the helical coil being configured to direct a flow of a refrigerant; a first baffle positioned radially inward of the inner portion and comprising a first opening at a first lower end of the first baffle; a second baffle positioned between the inner portion and the middle portion and comprising a second opening at a second upper end of the second baffle; and a third baffle positioned between the middle portion and the outer portion and comprising a third opening at a third lower end of the third baffle; and a pump connected to the evaporator by the inlet and the outlet, the pump being configured to force a drinking fluid through the evaporator and over the helical coil to exchange thermal energy with the refrigerant.

Clause 19. The system of clause 18, further comprising a condenser loop configured to decrease a temperature of the refrigerant.

Clause 20. The system of clause 18, further comprising a heat pipe configured to decrease a temperature of the refrigerant.

These and other aspects, features, and benefits of the claims will become apparent from the detailed written description of the aforementioned aspects taken in conjunction with the accompanying drawings, although variations and modifications thereto may be affected without departing from the spirit and scope of the novel concepts of the disclosure.

What is claimed is:

1. An evaporator, comprising:
a pressure vessel;
an evaporation device at least partially enclosed within the pressure vessel, the evaporation device being configured to direct a refrigerant through the pressure vessel; and
at least one fluid direction device at least partially enclosed within the pressure vessel, the at least one fluid direction device being configured to direct a drinking fluid around the evaporation device to facilitate heat exchange.

2. The evaporator of claim 1, wherein the evaporation device comprises an evaporation coil.

3. The evaporator of claim 2, wherein the evaporation coil comprises a first portion, a second portion, and a third portion, wherein the second portion is located radially exterior to the first portion and the third portion is located radially exterior to the second portion.

4. The evaporator of claim 2, wherein the evaporation coil is in fluid connection with an inlet and outlet of the pressure vessel.

5. The evaporator of claim 1, wherein the evaporation device comprises at least one evaporator fin.

6. The evaporator of claim 1, wherein the at least one fluid direction device comprises at least one baffle.

7. The evaporator of claim 6, wherein the at least one baffle comprises a first baffle, a second baffle, and a third baffle, wherein the second baffle is located radially exterior to the first baffle, and the third baffle is located radially exterior to the second baffle.

8. The evaporator of claim 6, wherein the at least one baffle comprises at least one opening configured to direct the drinking fluid.

9. The evaporator of claim 6, wherein the at least one baffle comprises at least one fin.

10. The evaporator of claim 1, wherein the at least one fluid direction device comprises at least one fin.

11. The evaporator of claim 1, wherein the evaporator excludes an intermediate working fluid between the refrigerant and the drinking fluid.

12. The evaporator of claim 1, further comprising a pump configured to pump the drinking fluid through the pressure vessel and over the evaporation device to exchange thermal energy with the refrigerant.

13. The evaporator of claim 1, further comprising at least one temperature sensor configured to measure a temperature of the drinking fluid.

14. The evaporator of claim 1, further comprising a pressure vessel cap configured to pressurize the pressure vessel.

15. The evaporator of claim 1, wherein the evaporator is configured to chill the drinking fluid for dispensing.

16. The evaporator of claim 1, wherein the drinking fluid is supplied to the evaporator via a demand pump.

17. An evaporator comprising:
a pressure vessel;
a helical coil positioned within the pressure vessel and comprising an inner portion, a middle portion, and an outer portion, wherein the middle portion is located radially exterior to the inner portion and the outer portion is located radially exterior to the middle portion;
a first baffle located radially interior to the inner portion and comprising a first opening at a first lower end of the first baffle;
a second baffle positioned between the inner portion and the middle portion and comprising a second opening at a second upper end of the second baffle; and
a third baffle positioned between the middle portion and the outer portion and comprising a third opening at a third lower end of the third baffle.

18. An evaporator system comprising:
an evaporator comprising:
a pressure vessel comprising an inlet and an outlet;
a helical coil enclosed inside the pressure vessel, the helical coil comprising an inner portion, a middle portion, and an outer portion, wherein the middle portion is located radially exterior to the inner portion and the outer portion is located radially exterior to the middle portion, and the helical coil being configured to direct a flow of a refrigerant;
a first baffle positioned radially inward of the inner portion and comprising a first opening at a first lower end of the first baffle;
a second baffle positioned between the inner portion and the middle portion and comprising a second opening at a second upper end of the second baffle; and
a third baffle positioned between the middle portion and the outer portion and comprising a third opening at a third lower end of the third baffle; and
a pump connected to the evaporator by the inlet and the outlet, the pump being configured to force a drinking fluid through the evaporator and over the helical coil to exchange thermal energy with the refrigerant.

19. The system of claim 18, further comprising a condenser loop configured to decrease a temperature of the refrigerant.

20. The system of claim 18. further comprising a heat pipe configured to decrease a temperature of the refrigerant.
